(19) United States
(12) Patent Application Publication
(10) Pub. No.: US 2015/0223107 A1
(43) Pub. Date: Aug. 6, 2015

(54) USER EQUIPMENT AND METHOD FOR APPLICATION SPECIFIC PACKET FILTER

(71) Applicant: Intel IP Corporation, Santa Clara, CA (US)

(72) Inventors: Robert Zaus, Munchen (DE); Jerome Parron, Fuerth (DE); Ana Lucia Pinheiro, Hillsboro, OR (US); Marta Martinez Tarradell, Hillsboro, OR (US); Hyung-Nam Choi, Hamburg (DE)

(21) Appl. No.: 14/575,101

(22) Filed: Dec. 18, 2014

Related U.S. Application Data
(60) Provisional application No. 61/933,872, filed on Jan. 31, 2014.

(51) Int. Cl. H04W 28/02

(52) U.S. Cl. CPC H04W 28/0263

(57) ABSTRACT

Application packet filters for mitigating traffic congestion in a network, and UEs and eNBs for using same, are disclosed. A UE may receive congestion control information of the network. The UE may compare the congestion control information with component values of one or more access control filters associated with a packet data network (PDN) connection to generate a congestion level comparison. The UE may transmit application data of an application matched to one of the one or more access control filters if the congestion level comparison indicates that transmission of the application data is allowed, and refrain from transmitting the application data otherwise. Other apparatuses, systems, and methods are disclosed.

### PRIORITY CLAIM

The present application for patent claims the benefit of priority under 35 U.S.C. 119(e) to U.S. Provisional Patent Application Ser. No. 61/933,872, entitled “USAGE OF FILTERING MECHANISMS TO SUPPORT APPLICATION SPECIFIC CONGESTION CONTROL,” filed Jan. 31, 2014, which is incorporated herein by reference in its entirety.

### TECHNICAL FIELD

Embodiments described herein pertain generally to wireless communications. More particularly, the present disclosure relates to congestion control in wireless communication networks, even more particularly for filtering mechanisms to support congestion control. Some embodiments pertain to wireless networks operating in accordance with a standard of the 3rd Generation Partnership Project (3GPP) family of standards.

### BACKGROUND

Packet filters act by inspecting data “packets” that are transferred between devices such as computers on the Internet, or user equipment (UEs) in a wireless network. If a data packet matches the packet filter's set of filtering rules, the packet filter may drop, discard, or forward the packet on to its appropriate destination. A packet filter may filter each packet based on information contained in the packet itself (most commonly using a combination of the packet's source and destination address, its protocol, and, for Transmission Control Protocol and User Datagram Protocol traffic, the port number).

The current Third Generation Partnership Project (3GPP) model provides limited means for application-specific packet filtering. The limited application differentiation means do not provide for application determined access control or traffic mitigation.

### BRIEF DESCRIPTION OF THE DRAWINGS

FIG. 1 is a network diagram illustrating traffic flows and packet filtering in a network, according to some example embodiments;

FIG. 2 shows a high level diagram illustrating an LTE protocol stack and packet filter functionality, according to some example embodiments;

FIG. 3 is a flowchart of an example method for application specific packet filtering in accordance with some embodiments;

FIG. 4 shows a functional diagram of an exemplary communication station in accordance with some embodiments; and

FIG. 5 illustrates a block diagram of an example of a machine upon which any one or more of the techniques (e.g., methodologies) discussed herein may be performed.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The word “exemplary” is used herein to mean “serving as an example, instance, or illustration.” Any embodiment described herein as “exemplary” is not necessarily to be construed as preferred or advantageous over other embodiments.

The terms “communication station”, “station”, “handheld device”, “mobile device”, “wireless device”, “User Equipment (UE),” as used herein, refer to a wireless communication device such as a cellular telephone, smartphone, tablet, netbook, wireless terminal, laptop computer, femtocell, High Data Rate (HDR) subscriber station, access point, access terminal, or other personal communication system (PCS) device. The device may be either mobile or stationary.

The current 3GPP model provides limited means for application-specific access control of radio resources, which is especially necessary when network traffic is congested. Currently, Access Class Barring (ACB) allows LTE networks to prevent UEs from performing initial Random Access Channel (RACH) access for specific access classes (i.e., certain groups of subscribers) and for some services, such as Circuit-Switched Fall-back (CSFB), while Service Specific Access Control (SSAC) allows the network to prevent UEs from performing any access for Internet Protocol Multimedia Subsystem (IMS) voice or video. Unfortunately, it is currently not possible to differentiate between most other applications such as gaming, web browsing or even Short Message Service (SMS). Additionally, ACB only applies during idle mode operation. SSAC and ACB are currently applied separately and in sequence, causing coordination of such functionality to be cumbersome within the UE.

A certain application or group of applications can often be characterized by one or several parameters which may be used to define a packet filter for user data packets that are sent by the application (or group of applications) toward the packet data network (PDN) using Internet Engineering Task Force (IETF) protocols such as Internet Protocol (IP), Transmission Control Protocol (TCP), User Datagram Protocol (UDP), Real-time Transport Protocol (RTP), etc. Examples of such already available parameters commonly used to define packet filters for the TFT (Traffic Flow Template) Information include IPv4 remote address, IPv6 remote address, IPv6 remote address/prefix length, Protocol identifier/Next header, Single local port, Local port range, Single remote port, Remote port range, Security parameter index, Type of service/Traffic class, and Flow label type (see, e.g., 3GPP TS 24.301 and 3GPP TS 24.008).

Today, when a PDN connection consists of several Evolved Packet System (EPS) bearers, each dedicated EPS bearer needs to have an associated TFT (the TFT is optional for the default EPS bearer). Each TFT contains one or more packet filters. When the UE transmits an uplink user data packet, it checks the packet filters across all its TFTs to determine if there is a packet filter match. Each packet filter comes with a “packet filter evaluation precedence.” The UE checks the packet filters starting with the filter having the highest evaluation precedence. When the UE finds a filter match, if delivers the user data packet to its associated EPS bearer for uplink transmission. If there is no match, the packet may be mapped into the default EPS bearer.

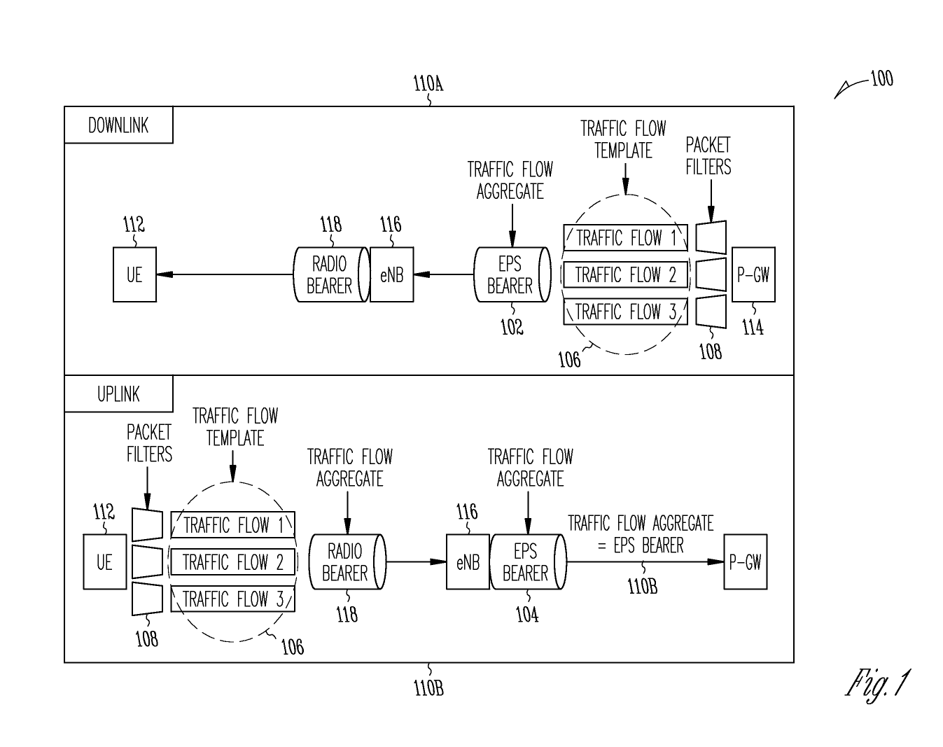

Novel access control filters for mitigating traffic congestion and for providing operational advantages are detailed in FIGS. 1-5. Components of the access control filters may indicate the type of application, permitted congestion level, or the priority level of the respective access control filter. The network may indicate to the UE, for example, the current network congestion level, or which application/application category or priority level is currently permitted, so that the UE may map this indication to the new access control filter components and determine whether the UE is allowed to transmit uplink user data packets matching the access control filter. If yes, the UE may then transmit the user data packet using the EPS bearer associated with a matching TFT packet filter. Various embodiments comprise adding one, or several, new access control filters for traffic congestion control and enhancing existing TFTs or creating a new information element including these new packet filters for the purpose of traffic congestion control.

FIG. 1 is a network diagram illustrating traffic flows and packet filtering in a network 100, according to some example embodiments. Each downlink EPS bearer 102 and uplink EPS bearer 104 is associated with a Quality of Service (QoS) level. A TFT 106 is assigned to each dedicated EPS bearer (102,104). The TFT 106 comprises one or more packet filters 108. The packet filters 108 function to inspect the data packet and match the information in the packet with the “filter contents.” Based on this match, the packet filter 108 assigns the packet to a specific traffic flow 110, and routes the packet accordingly.

LTE packet filter 108 components such as IP addresses and port numbers allow the UE 112 and the packet data network gateway (P-GW) 114 to filter every packet. The packet filters 108 permit multiple services to be mapped to the same EPS bearer (102,104). The packet filter 108 is applied in the UE 112 in the uplink and in the P-GW 114 in the downlink.

In a downlink traffic and data flow 110a, P-GW 114 output packets are filtered into TFTs 106 by the packet filters 108. Filtered packets are directed to matching downlink EPS bearer(s) 102. The LTE network provides the packets to an evolved Node-B (eNB) 116 for transmission by a Radio Bearer 118 to the UE 112. In an uplink traffic and data flow 110b, packets generated by the UE 112 are filtered into TFTs 106 by the packet filters 108. Filtered packets are provided to a Radio bearer 118 for transmission to an eNB 116, which directs the packets to an appropriate EPS bearer 104 for forwarding to the P-GW 114. Packet filter components such as IP addresses and port numbers allow the UE 112 and the P-GW 114 to filter every packet. The packet filters permit multiple services to be mapped to the same EPS bearer. The access control filters are applied in the UE 112 in the uplink and in the P-GW 114 or in the eNB 116 in the downlink.

Application specific packet filtering for wireless networks provides access control filters and enhancements to packet filters 108 according to components that characterize the packet so that the network operator can easily control or restrict the usage of some applications, as well as access to specific websites, during periods of network congestion. This type of network control can be implemented during connected mode when the bearers (102, 104, 118) are already established, rather than idle mode only. The network may broadcast, or transmit directly to a UE 112, a dedicated message comprising parameters such as the allowed congestion or priority levels, and application categories. If the network is broadcasting the allowed congestion or priority levels, or application categories, the UE 112 may also use this information to apply access control in idle mode because each application is delivering its uplink user data packets to a specific PDN connection, and the UE 112 may check the access control filters for access control for the respective PDN connection.

Currently-available systems provide only limited means for an application-specific access control during a congestion situation. Furthermore, some available congestion solutions can only be implemented when the UE 112 is in an idle mode. In contrast, example embodiments provide access control filters for mitigating traffic congestion and providing operational advantages. Other embodiments provide enhancements to existing packet filters. New packet filter components according to some embodiments may indicate parameters such as the type of application/application category, permitted congestion level, or the priority level of the filter. The eNB 116 may indicate to the UE 112 what is the current network congestion level, or which application, application category or priority level is currently permitted. Some embodiments provide congestion control enhancements to existing TFTs 106. The access control filter is applied in the UE 112 in the uplink only.

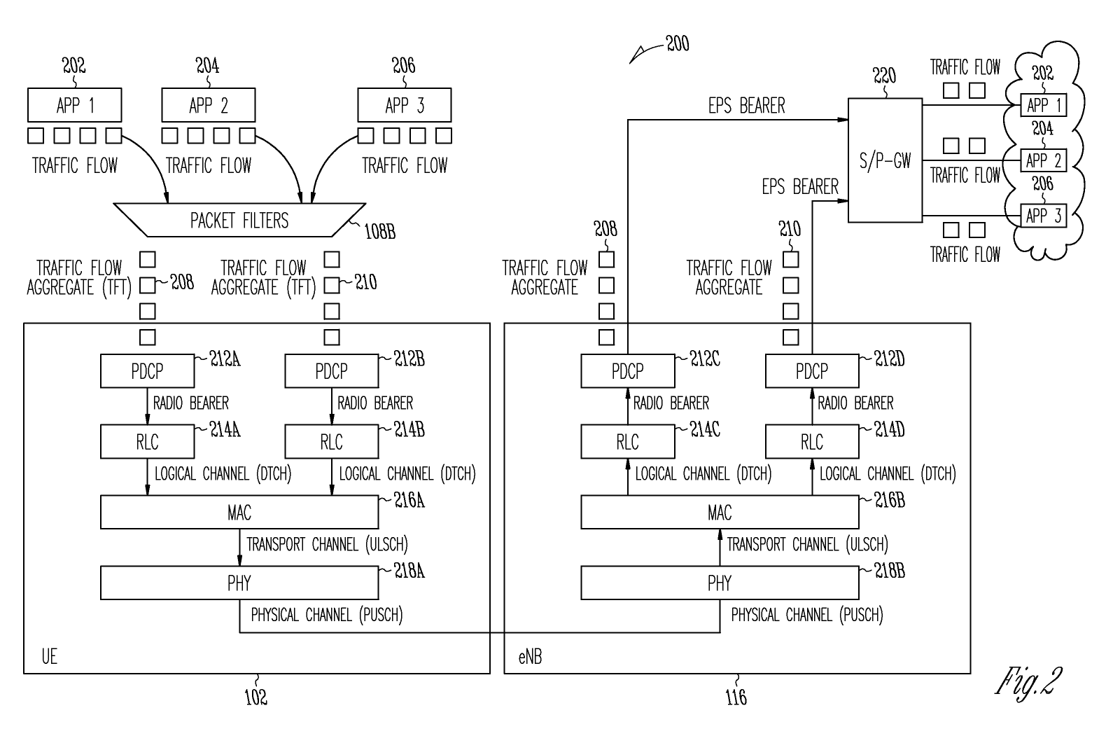

FIG. 2 shows a high level diagram illustrating an LTE protocol stack and packet filter functionality 200, according to some example embodiments. In the uplink traffic data flow 110b, the UE 112 uses the packet filter 108 to select a radio bearer 118 for traffic flow. Each traffic flow 110b is mapped to a radio bearer 118 via the packet filter 108. Multiple traffic flows may be mapped to the same radio bearer 118, forming a traffic flow aggregate 208, 210, which is represented by a TFT 106. Each radio bearer 118 maps to a logical channel, and all logical channels are multiplexed into a transport channel and then a physical channel.

The traffic flow aggregates (208,210), generated by Applications 202-206 at the UE 112 are processed for ciphering and integrity protection by the Packet Data Convergence Protocol (PDCP) layers 212a and 212b. The PDCP layer 212a, 212b converts the data of the traffic flow aggregates (208,210) to PDCP Protocol Data Units (PDUs) that are mapped to radio bearer(s) 118. The Radio Link Control (RLC) layer (214a, 214b) is responsible for transfer of upper layer Protocol Data Units (PDUs), error correction, and delivering the Application packets to the Medium Access Control (MAC) layer 216a. The MAC layer 216a performs mapping between logical channels and transport channels by multiplexing Service Data Units (SDUs) from one or different logical channels onto transport blocks (TB) to be delivered to the physical layer 218a on transport channels for transmission to a connected eNB 116.

The Physical layer 218b of the eNB 116 takes the transmitted Application packets from radio transport and prepares them for processing by the MAC layer 216b, which then maps them from their transport channels to logical channels for the RLC layer (214c, 214d). The RLC layer (214c, 214d) maps the Application packets to radio bearer(s) 118. The PDCP layer (212c, 212d) converts the PDCP PDUs received via the radio bearer(s) to the traffic flow aggregates (208,210) which are propagated via the EPS bearer(s) 102 to a Packet Data Network Gateway (S/P-GW) 220. The S/P-GW 220 de-multiplexes the traffic flow aggregates 208,210 into traffic flows for each application (202-206).

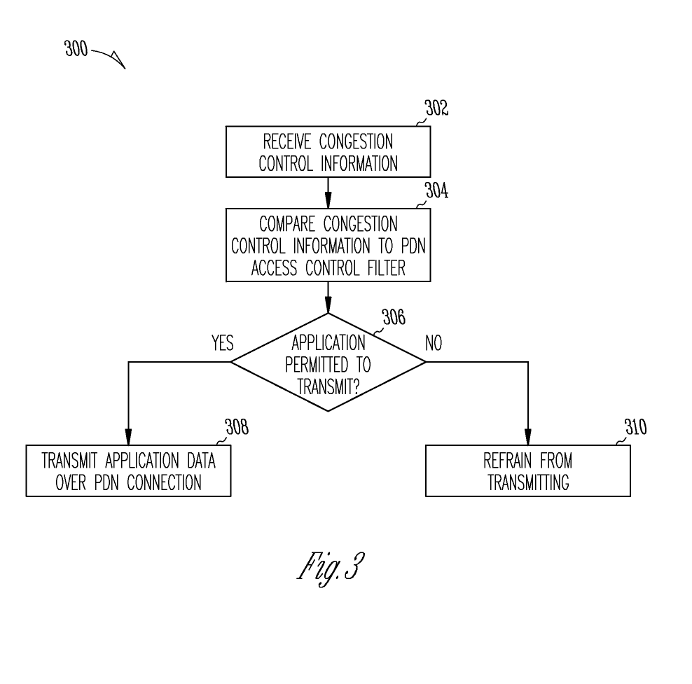

When received at an eNB 116, each traffic flow aggregate (208, 210) is associated with an EPS bearer 104 having a predetermined QoS. In the example shown in FIG. 2, Application 1 202 and Application 2 204 have the same QoS, while Application 3 206 has a different QoS from Application 1 202 and Application 2 204, so in sum the three applications are using two EPS bearers 104. The use of QoS level and other parameters for application specific filtering is detailed in FIGS. 3-5.

### Access Control Filter-Based Congestion Control

FIG. 3 is a flowchart of an example method 300 for application specific packet filtering in accordance with access control filter-based congestion control embodiments.

The example method 300 begins with operation 302, in which the UE 112 receives congestion control information of the network. For example, the congestion control information can include current congestion levels of the network or other access control information. In operation 304, the UE 112 compares congestion level information with component values (described later herein with respect to Tables 3-5) of at least one access control filter associated with the PDN connection upon, for example, establishment of the PDN connection, to generate a congestion level comparison. It will be understood that embodiments are not limited to only one access control filter.

An access control filter includes information that may be used by the UE 112 in combination with other information sent by the network to determine whether application data of an application matching the respective access control filter is permitted to be transmitted over the PDN connection for a given congestion level. With this mechanism the network operator can easily control or restrict the usage of some applications or the access to specific websites during congestion situations. This type of control may be used during connected mode when the bearers are established.

The network may broadcast or send a dedicated message to the UEs with the current congestion level and the UE will check the permitted level in the access control filter, and only transmit packets that respect the network-indicated congestion level. The UE may also save congestion control information and use the congestion control information for access control in idle mode, because each application is delivering its uplink user data packets to a specific PDN connection, and the UE can check the access control filters for access control for the respective PDN connection when the UE 112 is in idle mode. In various embodiments, the components of access control filters can take various forms, described in more detail later herein.

In access control filter-based embodiments, one or several access control filter components specifically for congestion control are defined. Access control filters are not associated with any specific TFT 106 or EPS bearer 102, 104. Rather, access control filters are associated with a PDN connection, and are used to decide which applications (or groups of applications) are permitted at various network congestion levels.

Access control filters are configured for a PDN connection when the PDN connection is established, i.e., upon activation of the default EPS bearer 104 in Evolved Universal Terrestrial Radio Access Network (E-UTRAN) or the default Packet Data Protocol (PDP) context in GSM EDGE Radio Access Network/Universal Terrestrial Radio Access Network (GERAN/UTRAN). The set of access control filters for a PDN connection can be modified by means of a network initiated EPS bearer modification procedure in Evolved Universal Terrestrial Radio Access Network (E-UTRAN) or a network initiated PDP context modification procedure in GSM EDGE Radio Access Network/Universal Terrestrial Radio Access Network (GERAN/UTRAN).

The example method 300 continues with operation 306 when the UE 112 determines in operation 306 whether the UE 112 can transmit application data of an application matched to a respective access control filter, based on the comparison of operation 304. Based on the determination in operation 306, the UE 112 may transmit application data in operation 308. Otherwise, the UE 112 refrains from transmitting the application data in operation 310.

Access control filters can include at least the bolded component in Table 3 (see below) for each access control filter to indicate the permitted congestion level of that access control filter. Optionally, in another embodiment, the access control filter can include the bolded component indicating the application 202-206 category or type of application 202-206 (see Table 4). Optionally, in yet another embodiment, a prioritized model can be used with priority levels assigned to each access control filter (see Table 5). In these embodiments, the network broadcasts an access priority level allowed, and any application mapped to an access control filter with access priority greater than or equal to the broadcasted allowed value can initiate communication. If an access control filter does not include any not bolded component from Table 3, 4 or 5, then any application data packet is considered to match this access control filter (“match-all” filter). Such an access control filter can be used e.g. to assign a default permitted congestion level for those application data packets that are not matching any other access control filter for the same PDN connection.

Because each access control filter is associated with an access control filter Identifier (ID), a new access control parameter may be introduced in further embodiments so that each access control filter ID can be mapped to one or more application 202-206 types or categories via this new parameter. Multiple access control filters may belong to an identical congestion level, set of application categories, or priority level.

In some embodiments, this association is implemented between the access control filter and the congestion level by associating a congestion level parameter field to each access control filter ID. This could be done by adding the “congestion level” parameter field in the “access control filter list” IE, as shown in Table 1.

TABLE 1
Access control filter list when the Access Control
Template (ACT) operation is “create new ACT”, or “add
access control filters to existing ACT” or
“replace access control filters in existing ACT”

| | | | | | | | |
|---|---|---|---|---|---|---|---|
| 8 | 7 | 6 | 5 | 4 | 3 | 2 | 1 |

| 0 | 0 | Access | Access control filter identifier |
|---|---|---|---|
| Spare | | control filter | 1 |
| | | direction 1 | |

Access control filter evaluation precedence 1
Length of Access control filter contents 1
Access control filter contents 1
Access control filter congestion level 1

| 0 | 0 | Access | Access control filter identifier |
|---|---|---|---|
| Spare | | control filter | 2 |
| | | direction 2 | |

Access control filter evaluation precedence 2
Length of Access control filter contents 2
Access control filter contents 2
Access control filter congestion level 2
. . .

| 0 | 0 | Access | Access control filter identifier |
|---|---|---|---|
| Spare | | control filter | N |
| | | direction N | |

Access control filter evaluation precedence N
Length of Access control filter contents N
Access control filter contents N
Access control filter congestion level N

In other embodiments, the association can be performed by adding a list of congestion level parameters in the Access control Template as shown in Table 2.

TABLE 2
Access control template information element

| | | | | | | | |
|---|---|---|---|---|---|---|---|
| 8 | 7 | 6 | 5 | 4 | 3 | 2 | 1 |

Access control template IEI
Length of Access control template IE

| ACT operation code | E bit | Number of Access control |
|---|---|---|
| | | filters |

Access control filter list
Parameters list
Access control filter congestion level list

The access control filters are independent f-rom the TFT packet filters 108 that determine the EPS bearer 104 for transferring uplink packets. When there is a sole default EPS bearer 104, one or more access control filters may be defined by the network, even when there is no TFT assigned to the default EPS bearer 104. When several access control filters are assigned to this single bearer, access control can be performed for different applications using the same PDN connection (i.e., a same Access Point Name) independently. Each access control filter comes with an “access control filter evaluation precedence.” The UE checks the access control filters starting with the filter having the highest evaluation precedence. When the UE finds a filter match, it uses the respective access control filter to perform the comparison of operation 304.

Access control filter-based embodiments allow the network operator to manage and control traffic congestion by restricting some UE 112 applications from accessing network resources. Application specific management and control may be used during connected mode when the bearers are established because the network can broadcast or send a dedicated message to a UE 112 carrying the current congestion level, permitted application 202-206 type or category, or permitted priority level. The UE will receive the current congestion level, permitted application category, or permitted priority level and apply access control for transmission of applications accordingly. The UE 112 can use the received information to also apply access control in idle mode because each application 202-206 is delivering its uplink user data packets to a specific PDN connection, so that the UE 112 can check the access control filters for the respective PDN connection while the UE 112 is in idle mode.

### TFT-Based Congestion Control

TFT based access control embodiments comprise identifying applications according to various components that are already used today in the TFT to define packet filters 108.

In accordance with some embodiments, TFT-based access control may use packet filter information to differentiate applications that should not be permitted to consume network and UE 112 resources during different network congestion levels. New packet filter components described below with respect to Tables 1-3 are added to the packet filter information to indicate, for example, the permitted congestion level of the packet passing through that filter. The packet filter may also be configured with a new application 202-206 type and/or category parameters which is then associated to the packet filter based on the packet filter ID.

TABLE 3
packet filter components according to a first example.

| | |
|---|---|
| 00010000 | IPv4 remote address type |
| 00010001 | IPv4 local address type |
| 00100000 | IPv6 remote address type |
| 00100001 | IPv6 remote address/prefix length type |
| 00100011 | IPv6 local address/prefix length type |
| 00110000 | Protocol identifier/Next header type |
| 01000000 | Single local port type |
| 01000001 | Local port range type |
| 01010000 | Single remote port type |
| 01010001 | Remote port range type |
| 01100000 | Security parameter index type |
| 01110000 | Type of service/Traffic class type |
| 10000000 | Flow label type |
| 11000000 | Permitted Congestion Level |

TABLE 4
packet filter components according to a second example.

| | |
|---|---|
| 00010000 | IPv4 remote address type |
| 00010001 | IPv4 local address type |
| 00100000 | IPv6 remote address type |
| 00100001 | IPv6 remote address/prefix length type |
| 00100011 | IPv6 local address/prefix length type |
| 00110000 | Protocol identifier/Next header type |
| 01000000 | Single local port type |
| 01000001 | Local port range type |
| 01010000 | Single remote port type |
| 01010001 | Remote port range type |
| 01100000 | Security parameter index type |
| 01110000 | Type of service/Traffic class type |
| 10000000 | Flow label type |
| 11000000 | Application Category |

TABLE 5
packet filter components according to a third example.

| | |
|---|---|
| 00010000 | IPv4 remote address type |
| 00010001 | IPv4 local address type |
| 00100000 | IPv6 remote address type |
| 00100001 | IPv6 remote address/prefix length type |
| 00100011 | IPv6 local address/prefix length type |
| 00110000 | Protocol identifier/Next header type |
| 01000000 | Single local port type |
| 01000001 | Local port range type |
| 01010000 | Single remote port type |
| 01010001 | Remote port range type |
| 01100000 | Security parameter index type |
| 01110000 | Type of service/Traffic class type |
| 10000000 | Flow label type |
| 11000000 | Priority Level |

As shown in Tables 3-5, applications may be identified in the packet filter e.g. by a remote IP address or a remote port or any combination thereof, provided that the network operator has knowledge of the remote IP address of the server to which the application on the UE 112 is sending uplink packets or knowledge of the port associated with the application on the server.

In one embodiment, the packet filter definition is augmented directly with the new component(s) (e.g., “Permitted Congestion Level,” Table 3, “Application Category,” Table 4, or “Priority Level,” Table 5). In other words, no new IE is required. When the TFT is configured, a new packet filter component for each of its packet filters indicates the permitted network congestion level for that packet filter.

For example, the TFT may be configured with a given “Permitted Congestion Level” component by defining a new component for each of its packet filters 108, using a reserved value for the packet filter component type identifier. In one embodiment, the value 11000000 may be used to identify the new “Permitted Congestion Level” packet filter component, although any other reserved value could be used. The augmented packet filter is shown above in Table 3, wherein the new “Permitted Congestion Level” packet filter component is shown in bold.

In another embodiment, shown in Table 4, the value 11000000 may be used to identify a new “Application Category” packet filter component although any other reserved value could be used.

Likewise, priority levels may be assigned to each packet filter. A network broadcast or dedicated message informs the UE 112 of permitted priority levels such that any packet mapped to a packet filter with a priority level equal to, or higher than, the permitted level may initiate communication. In this embodiment, the value 11000000 may be used to identify a new priority level packet filter component, although any other reserved value could be used. The augmented packet filter is shown in Table 5, above.

The network may control application 202-206 access for individual applications when multiple applications are mapped to the same EPS bearer 104 by assigning multiple packet filters 108 with separate congestion or priority levels to one TFT. A prioritized model may assign a different priority level to each packet filter such that when the network broadcasts a priority level allowed, any application 202-206 matched to a packet filter 108 in a TFT with a priority level equal to or higher than the broadcast priority level allowed value, can initiate communication.

Additionally, packet transmission can be controlled on the downlink as well as on the uplink. Either the P-GW 114 or eNB 116 can use the access control filter or the packet filter 108 to perform prioritization of application packet transmission during congestion conditions or other conditions. With this mechanism, a P-GW 114 or eNB 116 may easily control or restrict the usage of some applications, e.g. applications using push technology, or the access to specific websites, during periods of network congestion as directed by a network operator by performing operations 302-306. In operation 302, the P-GW 114 or eNB 116 receives congestion control information from other network nodes or creates congestion control information based on its own traffic load. For example, the congestion control information can include a current congestion level of the network or other access control information. In operation 304, the P-GW 114 or eNB 116 compares congestion level information with component values of at least one access control filter associated with the PDN connection or of at least one packet filter associated with a TFT to generate a congestion level comparison. In operation 306 the P-GW 114 or eNB 116 determines whether it can transmit application data of an application matched to a respective access control filter or packet filter, based on the comparison of operation 304. Based on the determination in operation 306, the P-GW 114 or eNB 116 may transmit application data in operation 308. Otherwise, the P-GW 114 or eNB 116 refrains from transmitting the application data in operation 310.

### Communication Station for Implementing Embodiments

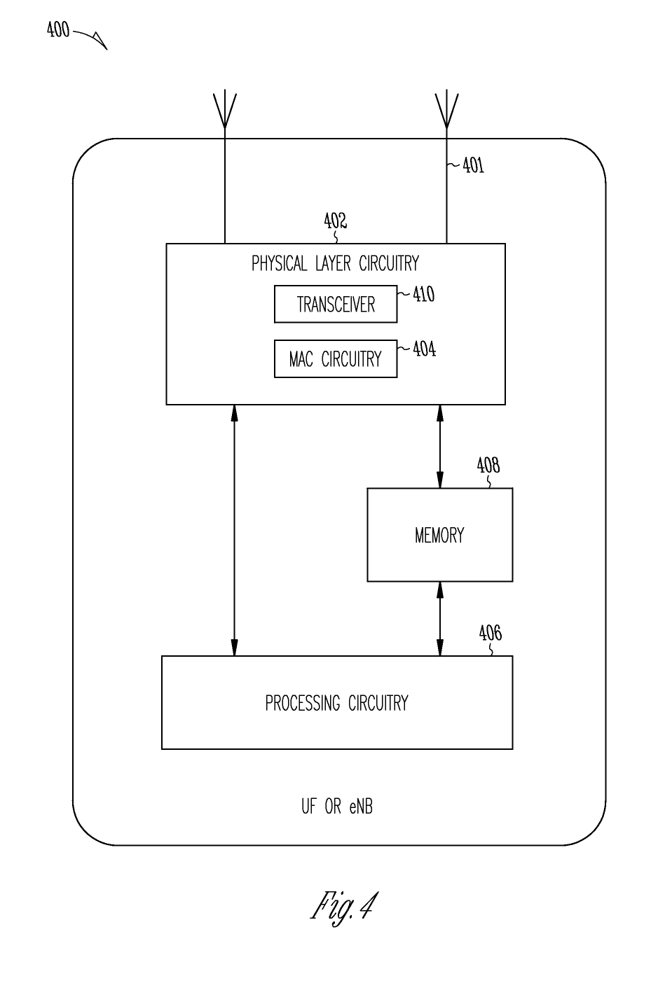

FIG. 4 shows a functional diagram of an exemplary communication station 400 in accordance with some embodiments. In one embodiment, FIG. 4 illustrates a functional block diagram of a communication station 400 that may be suitable for use as an eNB 116 or UE 112 (FIG. 1) in accordance with some embodiments. The communication station 400 may also be suitable for use as a handheld device, mobile device, cellular telephone, smartphone, tablet, netbook, wireless terminal, laptop computer, femtocell, High Data Rate (HDR) subscriber station, access point, access terminal, or other personal communication system (PCS) device. It should be noted that when the communication station 400 acts as an eNB 116, the communication station 400 may be stationary and non-mobile.

The communication station 400 may include physical layer circuitry 402 having transceiver circuitry 410 for transmitting and receiving signals to and from other UEs using one or more antennas 401. The physical layer circuitry 402 may also comprise medium access control (MAC) circuitry 404 for controlling access to the wireless medium. The communication station 400 may also include one or more processing circuitry 406 and memory 408 arranged to perform the operations described herein. In some embodiments, the physical layer circuitry 402 and the processing circuitry 406 may be configured to perform operations detailed with reference to FIGS. 1-3.

For example, when the communication station 400 acts as a UE 112 (FIG. 1), components of the processing circuitry 406 will compare network congestion control information with component values of an access control filter associated with a PDN connection to generate a congestion level comparison. The transceiver circuitry 410 will transmit application data of an application matched to the access control filter if the congestion level comparison indicates that transmission of the application data is allowed, and refrain from transmitting the application data otherwise.

When the communication station 400 acts as an eNB 116 (FIG. 1), components of the processing circuitry 406 and transceiver circuitry 410 can provide one or more access control filters associated with a PDN connection. As described above with reference to Tables 3-5, access control filters can include various component values that, when combined with network congestion level information, indicate whether application data of an application matched to the respective access control filter is permitted to be transmitted over the PDN connection. These component values can include values for permitted congestion levels at or below which transmission of the application data for an application matched to the respective access control filter is to be permitted on the PDN connection. Furthermore, the processing circuitry 406 and transceiver circuitry 410 can broadcast messages including, for example, the current congestion level to be used by the UE to determine whether an application is allowed to initiate communication. The processing circuitry 406 and transceiver circuitry 410 can perform prioritization of application packet transmission over a downlink based on a component value or component values in a respective packet filter.

In accordance with some embodiments, the MAC circuitry 404 may be arranged to contend for a wireless medium and configure frames or packets for communicating over the wireless medium, and the physical layer circuitry 402 may be arranged to transmit and receive signals. The physical layer circuitry 402 may include circuitry for modulation/demodulation, up-conversion/down-conversion, filtering, amplification, etc. In some embodiments, the processing circuitry 406 of the communication station 400 may include one or more processors. In some embodiments, two or more antennas 401 may be coupled to the physical layer circuitry 402 arranged for sending and receiving signals. The memory 408 may store information for configuring the processing circuitry 406 to perform operations for configuring and transmitting message frames and performing the various operations described herein. The memory 408 may comprise any type of memory, including non-transitory computer-readable storage media, for storing information in a form readable by a machine (e.g., a computer). For example, the memory 408 may comprise a computer-readable storage device, read-only memory (ROM), random-access memory (RAM), magnetic disk storage media, optical storage media, flash-memory devices, and other storage devices and media.

In some embodiments, the communication station 400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or another device that may receive and/or transmit information wirelessly.

In some embodiments, the communication station 400 may include one or more antennas 401. The antennas 401 may comprise one or more directional or omnidirectional antennas, including, for example, dipole antennas, monopole antennas, patch antennas, loop antennas, micro-strip antennas, or other types of antennas suitable for transmission of RF signals. In some embodiments, instead of two or more antennas 401, a single antenna 401 with multiple apertures may be used. In these embodiments, each aperture may be considered a separate antenna 401. In some multiple-input multiple-output (MIMO) embodiments, the antennas 401 may be effectively separated for spatial diversity and the different channel characteristics that may result between each of the antennas 401 and the antennas of a transmitting station.

In some embodiments, the communication station 400 may include one or more of a keyboard, a display, a non-volatile memory port, multiple antennas, a graphics processor, an application processor, speakers, and other mobile device elements (not shown). The display may be a Liquid Crystal Display (LCD) screen including a touch screen.

Although the communication station 400 is illustrated as having several separate functional elements, two or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs), and combinations of various hardware and logic circuitry for performing at least the functions described herein. In some embodiments, the functional elements of the communication station 400 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include Read-Only-Memory (ROM), random-access memory (RAM), magnetic disk storage media, optical storage media, flash-memory devices, and other storage devices and media. In some embodiments, the communication station 400 may include one or more processors and may be configured with instructions stored on a computer-readable storage device, which can include at least a portion of memory 408.

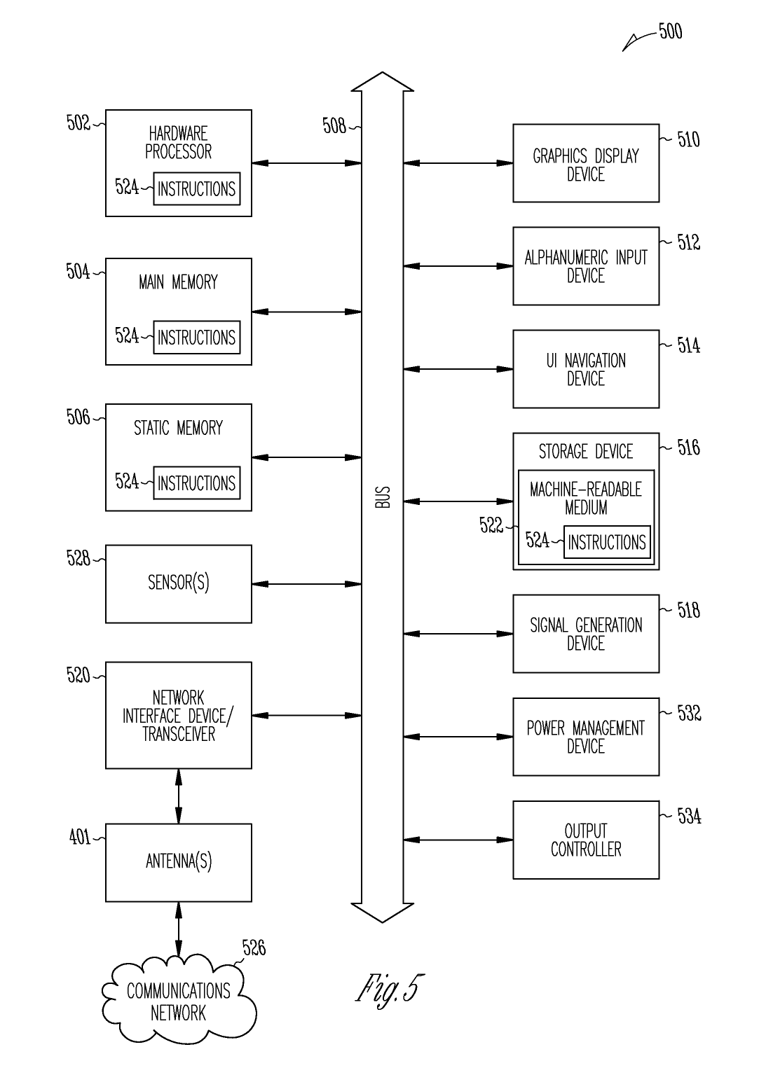

FIG. 5 illustrates a block diagram of an example of a machine 500 upon which any one or more of the techniques (e.g., methodologies) discussed herein may be performed. In one embodiment, the machine 500 may be a UE. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in a peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine, such as a base station. Further, while a single machine 500 is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a power management device 532, a graphics display device 510, an alphanumeric input device 512 (e.g., a keyboard), and a user interface (UI) navigation device 514 (e.g., a mouse). In an example, the graphics display device 510, alphanumeric input device 512, and UI navigation device 514 may be a touch screen display. The machine 500 may additionally include a storage device (i.e., drive unit) 516, a signal generation device 518 (e.g., a speaker), a network interface device/transceiver 520 coupled to antenna(s) 530, and one or more sensors 528, such as a global positioning system (GPS) sensor, compass, accelerometer, or other sensor. The machine 500 may include an output controller 534, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)

The storage device 516 may include a non-transitory computer-readable storage medium 522 on which is stored one or more sets of data structures or instructions 524 (e.g., software) embodying or utilized by any one or more of the techniques or functions described herein. The instructions 524 may also reside, completely or at least partially, within the main memory 504, within the static memory 506, or within the hardware processor 502 during execution thereof by the machine 500. In one embodiment, one or any combination of the hardware processor 502, the main memory 504, the static memory 506, or the storage device 516 may constitute computer-readable storage media.

While the computer-readable storage medium 522 is illustrated as a single medium, the term “computer-readable storage medium” may include a single medium or multiple media (e.g., a centralized or distributed database, and/or associated caches and servers) configured to store the one or more instructions 524.

The term “computer-readable storage medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions 524. Non-limiting computer-readable storage medium 522 examples may include solid-state memories, and optical and magnetic media. In an example, a massed computer-readable storage medium comprises a computer-readable storage medium 522 with a plurality of particles having resting mass. Specific examples of massed computer-readable storage media may include: non-volatile memory, such as semiconductor memory devices (e.g., Electrically Programmable Read-Only-Memory (EPROM), or Electrically Erasable Programmable Read-Only-Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device/transceiver 520 utilizing any one of a number of transfer protocols (e.g., frame relay, internet protocol (IP), transmission control protocol (TCP), user datagram protocol (UDP), hypertext transfer protocol (HTTP), etc.). Example communications networks 526 may include a local area network (LAN), a wide area network (WAN), a packet data network (e.g., the Internet), mobile telephone networks (e.g., cellular networks), Plain Old Telephone Service (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 520 may include one or more physical jacks (e.g., Ethernet, coaxial, or phone jacks) or one or more antennas 530 to connect to the communications network 526. In an example, the network interface device/transceiver 520 may include a plurality of antennas 530 to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions 524 for execution by the machine 500, and includes digital or analog communications signals or other intangible media to facilitate communication of such software.

### Additional Notes & Examples

Example 1 includes subject matter including an apparatus (e.g., a UE, wireless station, or other electrical apparatus) comprising processor and transceiver circuitry to receive congestion control information of the network; compare the congestion control information with component values of one or more access control filters associated with a packet data network (PDN) connection to generate a congestion level comparison; and transmit application data of an application matched to one of the one or more access control filters if the congestion level comparison indicates that transmission of the application data is allowed, and refrain from transmitting the application data otherwise.

In Example 2, the subject matter of Example 1 may optionally include wherein the processing and transceiver circuitry is further to operate in at least one of: an Evolved Universal Terrestrial Radio Access Network (E-UTRAN), a Universal Terrestrial Radio Access Network (UTRAN), or a GSM EDGE Radio Access Network (GERAN); and wherein the congestion control information of the network indicates a current congestion level of the network and wherein the one or more access control filters are generated and associated to the PDN connection upon establishment of the PDN connection.

In Example 3, the subject matter of any of Examples 1-2 may optionally include wherein the set of one or more access control filters can be modified by the network while the PDN connection exists.

In Example 4, the subject matter of any of Examples 1-3 may optionally include wherein a component value of at least one of the one or more access control filters includes an indication of a permitted congestion level at or below which transmission is permitted on the PDN connection for applications matched to the respective access control filter.

In Example 5, the subject matter of any of Examples 1-4 may optionally include wherein the processing and transceiver circuitry is further to receive the current congestion level in a broadcast message; save the current congestion level; and apply access control for transmission of application data based on the current congestion level during an idle mode of the UE for the PDN connection.

In Example 6, the subject matter of any of Examples 1-5 can optionally include wherein a component value of at least one of the one or more access control filters includes an indication of an application category for which the UE needs to receive permission from the network to transmit application data, if transmission on the PDN connection is to be allowed for applications matched to the access control filter.

In Example 7, the subject matter of any of Examples 1-6 can optionally include wherein at least one of the one or more access control filters includes a component having a value indicating a priority level which needs to be greater than or equal to a permitted priority level received from the network, if transmission on the PDN connection is to be allowed for applications matched to the access control filter.

In Example 8, the subject matter of Example 7 can optionally include wherein the processing and transceiver circuitry is further to receive the permitted priority level in a broadcast message; save the permitted priority level; and apply access control for transmission of application data based on the permitted priority level during an idle mode of the UE for the PDN connection.

In Example 9, the subject matter of any of Examples 1-8 can optionally include wherein the processing and transceiver circuitry is further to inspect a component value of a packet filter of a Traffic Flow Template (TFT) associated with an Evolved Packet System (EPS) bearer; and transmit the application data using the EPS bearer if the component value, when combined with the congestion control information, indicates that transmission of the application data is allowed, and refrain from transmitting the application data otherwise.

In Example 10, the subject matter of Example 9 can optionally include wherein the component value includes an indication of a permitted congestion level for the packet filter, at or below which transmission of the application data is permitted using the EPS bearer.

In Example 11, the subject matter of any of Examples 9-11 can optionally include wherein the component value includes an indication of an application category for which the UE needs to receive permission from the network to transmit application data, if transmission using the EPS bearer is to be allowed for applications matched to the packet filter.

In Example 12, the subject matter of any of Examples 9-11 can optionally include wherein the component value includes a priority level for the packet filter, and wherein the processing and transceiver circuitry is further to receive, in a broadcast message from the E-UTRAN, a permitted priority level for which transmission of application data is permitted on the network; and transmit the application data if the component value indicates that the priority level of the packet filter is greater than or equal to the permitted priority level, and refrain from transmitting the application data otherwise.

Example 13 include subject matter (such as a an evolved Node-B (eNB), base station, or other device) comprising processor and transceiver circuitry to provide one or more access control filters associated with a packet data network (PDN) connection, the one or more access control filters including component values that, when combined with network congestion level information, indicate whether application data of an application matched to the respective access control filter is permitted to be transmitted over the PDN connection.

In Example 14, the subject matter of Example 13 can optionally include wherein the component values include a permitted congestion level for the respective access control filter, at or below which transmission of the application data for an application matched to the respective access control filter is to be permitted on the PDN connection.

In Example 15, the subject matter of any of Examples 13-14 can optionally include wherein the processing and transceiver circuitry is further to transmit a current congestion level in a broadcast message.

In Example 16, the subject matter of any of Examples 13-15 can optionally include wherein the processing and transceiver circuitry is further to perform prioritization of application packet transmission over a downlink based on component values in a respective access control filter.

Example 17 includes subject matter such as a non-transitory computer-readable storage medium that stores instructions for execution by one or more processors of user equipment (UE) in a network, the operations to configure the UE to compare congestion level information of the network with component values for one or more access control filters associated with a packet data network (PDN) connection to generate a congestion level comparison; and transmit application data of an application matched to one of the one or more access control filters if the congestion level comparison indicates that transmission of the application data is allowed, and refrain from transmitting the application data otherwise.

In Example 18, the subject matter of Example 17 can optionally include wherein the access control filter includes a component having a value indicating one of a permitted congestion level at or below which transmission is permitted on the PDN connection, a priority level which needs to be greater than or equal to a permitted priority level, if transmission is to be permitted on the PDN connection, and an application category for which the one or more processors need to receive permission from the network to transmit application data, if transmission on the PDN connection is to be allowed.

In Example 19, the subject matter of any of Examples 17-18 can optionally include further storing instructions for execution by one or more processors to perform operations in a network, the operations to further configure the one or more processors to receive a current congestion level in a broadcast message; save the current congestion level; and apply access control for transmission of application data based on the current congestion level during an idle mode of the UE for the PDN connection.

Example 20 includes subject matter such as a method, and means for performing such a method, the method include operations of receiving congestion control information of the wireless communication network; comparing the congestion control information with component values of one or more access control filters associated with a packet data network (PDN) connection to generate a congestion level comparison; transmitting application data of an application matched to one of the one or more access control filters if the congestion level comparison indicates that transmission of the application data is allowed, and refrain from transmitting the application data otherwise; and operating in at least one of an Evolved Universal Terrestrial Radio Access Network (E-UTRAN), a Universal Terrestrial Radio Access Network (UTRAN), or a GSM EDGE Radio Access Network (GERAN).

Example 21 includes the subject matter of Example 20, and optionally comprising receiving values for one of current congestion level, permitted application category, and permitted priority level for the PDN connection in a broadcast message; saving the values; and applying access control for transmission of application data based on at least one of the values during an idle mode of the UE for the PDN connection.

What is claimed is:

1. A user equipment (UE) comprising hardware processing circuitry to:
receive congestion control information of a network;
compare the congestion control information with component values of one or more access control filters associated with a packet data network (PDN) connection to generate a congestion level comparison; and
transmit application data of an application matched to one of the one or more access control filters if the congestion level comparison indicates that transmission of the application data is allowed, and refrain from transmitting the application data otherwise.

2. The UE of claim 1, wherein the processing and transceiver circuitry is further to:
wherein the network comprises at least one of an Evolved Universal Terrestrial Radio Access Network (E-UTRAN), a Universal Terrestrial Radio Access Network (UTRAN), or a GSM EDGE Radio Access Network (GERAN); and
wherein the congestion control information of the network indicates a current congestion level of the network and wherein the one or more access control filters are generated and associated to the PDN connection upon establishment of the PDN connection.

3. The UE of claim 2, wherein the set of one or more access control filters is configurable to be modified by the network while the PDN connection exists.

4. The UE of claim 2, wherein a component value of at least one of the one or more access control filters includes an indication of a permitted congestion level at or below which transmission is permitted on the PDN connection for applications matched to the respective access control filter.

5. The UE of claim 4, wherein the processing and transceiver circuitry is further to:
receive the current congestion level in a broadcast message;
save the current congestion level; and
apply access control for transmission of application data based on the current congestion level during an idle mode of the UE for the PDN connection.

6. The UE of claim 2, wherein a component value of at least one of the one or more access control filters includes an indication of an application category for which the UE is to receive permission from the network to transmit application data, if transmission on the PDN connection is to be allowed for applications matched to the access control filter.

7. The UE of claim 2, wherein at least one of the one or more access control filters includes a component having a value indicating a priority level which is to be greater than or equal to a permitted priority level received from the network, if transmission on the PDN connection is to be allowed for applications matched to the access control filter.

8. The UE of claim 7, wherein the processing and transceiver circuitry is further to:
receive the permitted priority level in a broadcast message;
save the permitted priority level; and
apply access control for transmission of application data based on the permitted priority level during an idle mode of the UE for the PDN connection.

9. The UE of claim 2, wherein the processing and transceiver circuitry is further to:
inspect a component value of a packet filter of a Traffic Flow Template (TFT) associated with an Evolved Packet System (EPS) bearer; and
transmit the application data using the EPS bearer if the component value, when combined with the congestion control information, indicates that transmission of the application data is allowed, and refrain from transmitting the application data otherwise.

10. The UE of claim 9, wherein the component value includes an indication of a permitted congestion level for the packet filter, at or below which transmission of the application data is permitted using the EPS bearer.

11. The UE of claim 9, wherein the component value includes an indication of an application category for which the UE needs to receive permission from the network to transmit application data, if transmission using the EPS bearer is to be allowed for applications matched to the packet filter.

12. The UE of claim 9, wherein the component value includes a priority level for the packet filter, and wherein the processing and transceiver circuitry is further to:
receive, in a broadcast message from the E-UTRAN, a permitted priority level for which transmission of application data is permitted on the network; and
transmit the application data if the component value indicates that the priority level of the packet filter is greater than or equal to the permitted priority level, and refrain from transmitting the application data otherwise.

13. The UE of claim 1, further comprising one or more antennas.

14. An evolved Node-B (eNB) comprising hardware processing circuitry to:
provide one or more access control filters associated with a packet data network (PDN) connection, the one or more access control filters including component values that, when combined with network congestion level information, indicate whether application data of an application matched to the respective access control filter is permitted to be transmitted over the PDN connection; and
receive uplink application data matched to the one or more access control filters.

15. The eNB of claim 14, wherein the component values include a permitted congestion level for the respective access control filter, at or below which transmission of the application data for an application matched to the respective access control filter is to be permitted on the PDN connection.

16. The eNB of claim 15, wherein the processing and transceiver circuitry is further to
transmit a current congestion level in a broadcast message.

17. The eNB of claim 14, wherein the processing and transceiver circuitry is further to perform prioritization of application packet transmission over a downlink based on component values in a respective access control filter.

18. A non-transitory computer-readable storage medium that stores instructions for execution by one or more processors of user equipment (UE) in a network, the operations to configure the UE to:
compare congestion level information of the network with component values for one or more access control filters associated with a packet data network (PDN) connection to generate a congestion level comparison; and
transmit application data of an application matched to one of the one or more access control filters if the congestion level comparison indicates that transmission of the application data is allowed, and refrain from transmitting the application data otherwise.

19. The non-transitory computer-readable storage medium of claim 18, wherein the access control filter includes a component having a value indicating one of
a permitted congestion level at or below which transmission is permitted on the PDN connection,
a priority level which needs to be greater than or equal to a permitted priority level, if transmission is to be permitted on the PDN connection, and
an application category for which the one or more processors need to receive permission from the network to transmit application data, if transmission on the PDN connection is to be allowed.

20. The non-transitory computer-readable storage medium of claim 18, further storing instructions for execution by one or more processors to perform operations in a network, the operations to further configure the one or more processors to:
receive a current congestion level in a broadcast message;
save the current congestion level; and
apply access control for transmission of application data based on the current congestion level during an idle mode of the UE for the PDN connection.

21. A method performed by a user equipment (UE) in a wireless communication network, the method comprising:
receiving congestion control information of the wireless communication network;
comparing the congestion control information with component values of one or more access control filters associated with a packet data network (PDN) connection to generate a congestion level comparison; and
operating in at least one of an Evolved Universal Terrestrial Radio Access Network (E-UTRAN), a Universal Terrestrial Radio Access Network (UTRAN), or a GSM EDGE Radio Access Network (GERAN).

22. The method of claim 20, further comprising:
transmitting application data of an application matched to one of the one or more access control filters if the congestion level comparison indicates that transmission of the application data is allowed, and refrain from transmitting the application data otherwise;
receiving values for one of current congestion level, permitted application category, and permitted priority level for the PDN connection in a broadcast message;
saving the values; and
applying access control for transmission of application data based on at least one of the values during an idle mode of the UE for the PDN connection.
